(19) United States
(12) Patent Application Publication
(10) Pub. No.: US 2009/0160985 A1
(43) Pub. Date: Jun. 25, 2009

(54) METHOD AND SYSTEM FOR RECOGNITION OF A TARGET IN A THREE DIMENSIONAL SCENE

(75) Inventors: Bahram Javidi, Storrs, CT (US); Seung-Hyun Hong, Storrs, CT (US)

Correspondence Address: CANTOR COLBURN, LLP, 20 Church Street, 22nd Floor, Hartford, CT, 06103, US

(73) Assignee: THE UNIVERSITY OF CONNECTICUT, Farmington, CT (US)

(21) Appl. No.: 12/331,984

(22) Filed: Dec. 10, 2008

Related U.S. Application Data
(60) Provisional application No. 61/007,043, filed on Dec. 10, 2007.

(51) Int. Cl. H04N 5/335; G06T 15/00; G06K 9/00

(52) U.S. Cl. 348/294; 345/419; 382/103; 348/E05.091

(57) ABSTRACT

A method for three-dimensional reconstruction of a three-dimensional scene and target object recognition may include acquiring a plurality of elemental images of a three-dimensional scene through a microlens array; generating a reconstructed display plane based on the plurality of elemental images using three-dimensional volumetric computational integral imaging; and recognizing the target object in the reconstructed display plane by using an image recognition or classification algorithm.

### CROSS REFERENCE TO RELATED APPLICATIONS

This application claims the benefit of the date of the earlier filed provisional application, U.S. Provisional Application Number 61/007,043, filed on Dec. 10, 2007, the contents of which are incorporated by reference herein in its entirety.

### FIELD OF THE INVENTION

The present invention relates generally to the fields of imaging systems; three-dimensional (3D) image processing; 3D image acquisition; and systems for recognition of objects and targets.

### BACKGROUND

Three-dimensional (3D) imaging and visualization techniques have been the subject of great interest. Integral imaging is a promising technology among 3D imaging techniques. Integral imaging systems use a microlens array to capture light rays emanating from 3D objects in such a way that the light rays that pass through each pickup microlens are recorded on a two-dimensional (2D) image sensor. The captured 2D image arrays are referred to as elemental images. The elemental images are 2D images, flipped in both the x and y direction, each with a different perspective of a 3D scene. To reconstruct the 3D scene optically from the captured 2D elemental images, the rays are reversely propagated from the elemental images through a display microlens array that is similar to the pickup microlens array.

In order to overcome image quality degradation introduced by optical devices used in an optical integral imaging reconstruction process, and also to obtain arbitrary perspective within the total viewing angle, computational integral imaging reconstruction techniques have been proposed (see H. Arimoto and B. Javidi, “Integral three-dimensional imaging with digital reconstruction,” Opt. Lett. 26,157-159 (2001); A. Stem and B. Javidi, “Three-dimensional image sensing and reconstruction with time-division multiplexed computational integral imaging,” Appl. Opt. 42, 7036-7042 (2003); M. Martinez-Corral, B. Javidi, R. Martinez-Cuenca, and G. Saavedra, “Integral imaging with improved depth of field by use of amplitude modulated microlens array,” Appl. Opt. 43, 5806-5813 (2004); S.-H. Hong, J.-S. Jang, and B. Javidi, “Three-dimensional volumetric object reconstruction using computational integral imaging,” Opt. Express 12, 483-491 (2004), www.opticsexpress.org/abstract.cfm?URI=OPEX-12-3-483; and S. Yeom, B. Javidi, and E. Watson, “Photon counting passive 3D image sensing for automatic target recognition,” Opt. Express 13, 9310-9330 (2005), www.opticsinfobase.org/abstract.cfm?URI=oe-13-23-9310).

The reconstructed high resolution image that could be obtained with resolution improvement techniques is an image reconstructed from a single viewpoint. Recently, a volumetric computational integral imaging reconstruction method has been proposed, which uses all of the information of the elemental images to reconstruct the full 3D volume of a scene. It allows one to reconstruct 3D voxel values at any arbitrary distance from the display microlens array.

In a complex scene, some of the foreground objects may occlude the background objects, which prevents us from fully observing the background objects. To reconstruct the image of the occluded background objects with the minimum interference of the occluding objects, multiple images with various perspectives are required. To achieve this goal, a volumetric II reconstruction technique with inverse projection of the elemental images has been applied to the occluded scene problem (see S.-H. Hong and Bahram Javidi, “Three-dimensional visualization of partially occluded objects using integral Imaging,” IEEE J. Display Technol. 1, 354-359 ( 2005)).

Many pattern recognition problems can be solved with the correlation approach. To be distortion tolerant, the correlation filter should be designed with a training data set of reference targets to recognize the target viewed from various rotated angles, perspectives, scales and illuminations. Many composite filters have been proposed according to their optimization criteria. An optimum nonlinear distortion tolerant filter is obtained by optimizing the filter's discrimination capability and noise robustness to detect targets placed in a non-overlapping (disjoint) background noise. The filter is designed to maintain fixed output peaks for the members of the true class training target set. Because the nonlinear filter is derived to minimize the mean square error of the output energy in the presence of disjoint background noise and additive overlapping noise, the output energy is minimized in response to the input scene, which may include the false class objects.

One of the challenging problems in pattern recognition is the partial occlusion of objects, which can seriously degrade system performance. Most approaches to this problem have been addressed by the development of specific algorithms, such as statistical techniques or contour analysis, applied to the partially occluded 2D image. In some approaches it is assumed that the objects are planar and represented by binary values. Scenes involving occluded objects have been studied recently by using 3D integral imaging systems with computational reconstruction. The reconstructed 3D object in the occluded scene can be correlated with the original 3D object.

In view of these issues, there is a need for improvements in distortion-tolerant 3D recognition of occluded targets. At least an embodiment of a method and system for 3D recognition of an occluded target may include an optimum nonlinear filter technique to detect distorted and occluded 3D objects using volumetric computational integral imaging reconstruction.

### SUMMARY OF THE INVENTION

At least an embodiment of a method for three-dimensional reconstruction of a three-dimensional scene and target object recognition may include acquiring a plurality of elemental images of a three-dimensional scene through a microlens array; generating a reconstructed display plane based on the plurality of elemental images using three-dimensional volumetric computational integral imaging; and recognizing the target object in the reconstructed display plane by using an image recognition or classification algorithm.

At least an embodiment of a system for three-dimensional reconstruction of a three-dimensional scene and target object recognition may include a CCD camera structured to record a plurality of elemental images; a microlens array positioned between the CCD camera and the three-dimensional scene; a processor connected to the CCD camera, the processor being structured to generate a reconstructed display plane based on the plurality of elemental images using three-dimensional volumetric computational integral imaging and structured to recognize the target object in the reconstructed display plane by using an image recognition or classification algorithm.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram of at least an embodiment of a system for 3D recognition of an occluded target.

FIG. 2 is a diagram of at least an embodiment of a system for capturing elemental images of a 3D scene.

FIG. 3 is a diagram of at least an embodiment of a system for performing 3D volumetric reconstruction integral imaging.

FIG. 4(a) is an image showing a 3D scene used in evaluating at least an embodiment of a method and system for 3D recognition of an occluded target.

FIG. 4(b) is an image showing a 3D scene with occlusions.

FIGS. 5(a)-5 (d) show various reconstructed views of the 3D scene shown in FIG. 4(b).

FIG. 6 is an image showing a 3D scene with occlusions.

FIGS. 7-13 shows various view of reconstructed images used as training reference images.

FIGS. 14(a)-14(d) show various views of a reconstructed 3D scene.

FIGS. 15(a)-15(d) show various views of a reconstructed 3D scene.

FIGS. 16(a)-16(d) show the output from one embodiment of a normalized optimum nonlinear filter for the reconstructed 3D scene shown in FIGS. 14(a)-14(d).

FIGS. 17(a)-17(d) show the output from one embodiment of a normalized optimum nonlinear filter for the reconstructed 3D scene shown in FIGS. 15(a)-15(d).

FIG. 18 shows an example of a captured elemental image set.

### DETAILED DESCRIPTION OF PREFERRED EMBODIMENTS

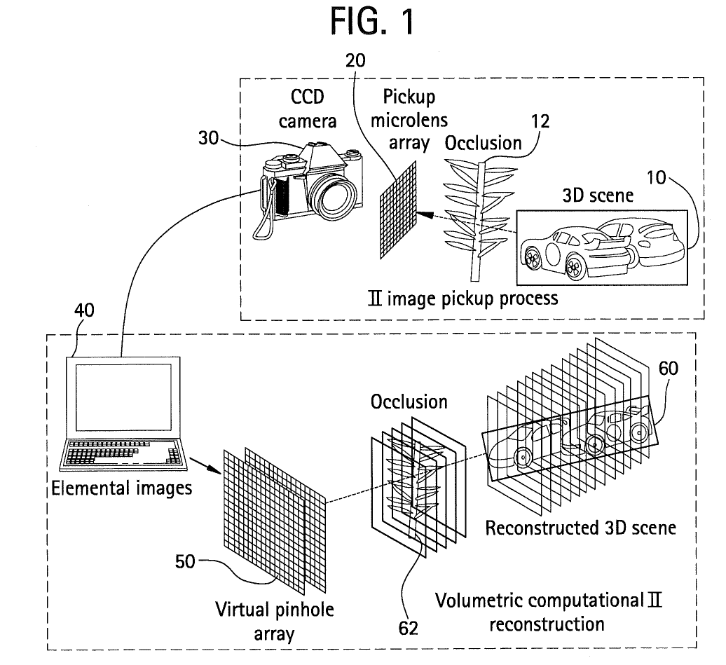

As seen in FIGS. 1-3, each voxel of a 3D scene can be mapped into the imaging plane of the pickup microlens array 20 and can form the elemental images in the pickup process of the integral imaging system within the viewing angle range of the system. Each recorded elemental image conveys a different perspective and different distance information of the 3D scene. The 3D volumetric computational integral imaging reconstruction method extracts pixels from the elemental images by an inverse mapping through a computer synthesized (virtual) pinhole array 50, and displays the corresponding voxels on a desired display plane 68. The sum of the display planes 68 results in the reconstructed 3D scene. The elemental images inversely mapped through the synthesized pinhole array 50 may overlap each other at any depth level from the virtual pinhole array 50 for M>1, where M is the magnification factor. It is the ratio of the distance, z, between the synthesized pinhole array 50 and the reconstruction image plane 68 to the distance, g, between the synthesized pinhole array 50 and the elemental image plane 32, that is M=z/g. The intensity at the reconstruction plane is inversely proportional to the square of the distance between the elemental image plane 32 and the reconstruction plane 68. The inverse mappings of all the elemental images corresponding to the magnification factor M form a single image at any reconstruction image plane 68. To form the 3D volume information, this process is repeated for all reconstruction planes 68 of interest with different distance information. In this manner, all of the information of the recorded elemental images is used to reconstruct a full 3D scene, which requires simple inverse mapping and superposition operations.

Since it is possible to reconstruct display planes 68 of interest with volumetric computational integral imaging reconstruction, it is possible to separate the reconstructed background objects 60 from the reconstructed foreground objects 62. In other words, it is possible to reconstruct the image of the original background object 10 with a reduced effect of the original foreground occluding objects 12. However, there is a constraint on the distance between the foreground objects 10 and background objects 12. The minimum distance between the occluding object and a pixel on the background object is d₀×l_{c}l(n−1)p, where d₀ is the distance between the virtual pinhole array and the pixel of the background object, l_{c} is the length of the occluding foreground object, p is the pitch of the virtual pinhole, and n is the rhombus index number which defines a volume in the reconstructed volume.

As described in detail below rᵢ(t) denotes one of the distorted reference targets where i=1, 2, . . . , T, and T is the size of reference target set. The input image s(t) which may include distorted targets is

$$s ( t ) = {\sum }_{i = 1}^{T} {v}_{i} {r}_{i} ( t - {τ}_{i} ) + {n}_{b} ( t ) [ w ( t ) - {\sum }_{i = 1}^{T} {v}_{i} {w}_{r i} ( t - {τ}_{i} ) ] + {n}_{a} ( t ) {w ( t )}^{′} \qquad ( 1 )$$

where vᵢ is a binary random variable which takes a value of 0 or 1, of which probability mass functions are p(vᵢ=1)=1/T and p(vᵢ=0)=1−1T. In Eq. (1), vᵢ indicates whether the target rᵢ(t) is present in the scene or not. If rᵢ(t) is one of the reference targets, n_{b}(t) is the non-overlapping background noise with mean m_{b}, nₐ(t) is the overlapping additive noise with mean mₐ, w(t) is the window function for the entire input scene, wᵣᵢ(t) is the window function for the reference target rᵢ(t), τᵢ is a uniformly distributed random location of the target in the input scene, whose probability density function is f (τᵢ)=w(τᵢ)l d (d is the area of the support region of the input scene). n_{b}(t) and nₐ(t) are assumed to be wide-sense stationary random processes and statistically independent to each other.

The filter is designed so that when the input to the filter is one of the reference targets, then the output of the filter in the Fourier domain expression becomes

$${\sum }_{k = 0}^{M - 1} H ( k ) * {R}_{i} ( k ) = M {C}_{i}^{′} \qquad ( 2 )$$

where H(k) and Rᵢ(k) are the discrete Fourier transforms of h(t) (impulse response of the distortion tolerant filter) and rᵢ(t), respectively, * denotes complex conjugate, M is the number of sample pixels, and Cᵢ is a positive real desired constant. Equation (2) is the constraint imposed on the filter. To obtain noise robustness, the output energy due to the disjoint background noise and additive noise is minimized. Both disjoint background noise and additive noise can be integrated and represented in one noise term as

$$n ( t ) = {n}_{b} ( t ) \{ w ( t ) - {\sum }_{i = 1}^{T} {v}_{i} {w}_{r i} ( t - {τ}_{i} ) \} + {n}_{a} ( t ) w ( t ) .$$

A linear combination of the output energy due to the input noise and the output energy due to the input scene is minimized under the filter constraint in Eq. (2).

Let aₖ+jbₖ be the k-th element of H(k), and cᵢₖ+jdᵢₖ be the k-th element of Rᵢ(k), and D(k)=(wₙE|N(k)|²+w_{d}|S(k)|²)/M in which E is the expectation operator, N(k) is the Fourier transform of n(t) , S(k) is the Fourier transform of s(t), wₙ and w_{d} are the positive weights of the noise robustness capability and discrimination capability, respectively. Now, the problem is to minimize

$$\frac{{w}_{n}}{M} {\sum }_{k = 0}^{M - 1} {\vert H ( k ) \vert}^{2} E {\vert N ( k ) \vert}^{2} + \frac{{w}_{d}}{M} {\sum }_{k = 0}^{M - 1} {\vert H ( k ) \vert}^{2} {\vert S ( k ) \vert}^{2} = {\sum }_{k = 0}^{M - 1} ( {a}_{k}^{2} + {b}_{k}^{2} ) D ( k ) \qquad ( 3 )$$

with the real and imaginary part constrained, because MCᵢ is a real constant in Eq. (2). The Lagrange multiplier is used to solve this minimization problem. Let the function to be minimized with the Lagrange multipliers λ₁ᵢ, λ₂ᵢ be

$$J ≡ {\sum }_{k = 0}^{M - 1} ( {a}_{k}^{2} + {b}_{k}^{2} ) D ( k ) + {\sum }_{i = 1}^{T} {λ}_{1 i} ( M {C}_{i} - {\sum }_{k = 0}^{M - 1} {a}_{k} {c}_{i k} - {\sum }_{k = 0}^{M - 1} {b}_{k} {d}_{i k} ) + {\sum }_{i = 1}^{T} {λ}_{2 i} ( 0 - {\sum }_{k = 0}^{M - 1} {a}_{k} {d}_{i k} + {\sum }_{k = 0}^{M - 1} {b}_{i k} {c}_{i k} ) \qquad ( 4 )$$

One must find aₖ, bₖ, and λ₁ᵢ, λ₂ᵢ that satisfy filter constraints. Values can be obtained for aₖ and bₖ that minimize J and satisfy the required constraints,

$${a}_{k} = \frac{{\sum }_{i = 1}^{T} ( {λ}_{1 i} {c}_{i k} + {λ}_{2 i} {d}_{i k} )}{2 D ( k )} , {b}_{k} = \frac{{\sum }_{i = 1}^{T} ( {λ}_{1 i} {d}_{i k} - {λ}_{2 i} {c}_{i k} )}{2 D ( k )} . \qquad ( 5 )$$

The following additional notations are used to complete the derivation,

$${λ}_{1} ≡ {[ {λ}_{11} {λ}_{12} … {λ}_{1 T} ]}^{t} , {λ}_{2} ≡ {[ {λ}_{21} {λ}_{22} … {λ}_{2 T} ]}^{t} , C ≡ {[ {C}_{1} {C}_{2} … {C}_{T} ]}^{t} , \\ {A}_{x , y} ≡ {\sum }_{k = 0}^{M - 1} \frac{Re [ {R}_{x} ( k ) ] Re [ {R}_{y} ( k ) ] + Im [ {R}_{x } ( k ) ] Im [ {R}_{y} ( k ) ]}{2 D ( k )} = {\sum }_{k = 0}^{M - 1} \frac{{c}_{xk} {c}_{yk} + {d}_{xk} {d}_{yk}}{2 D ( k )} , \\ {B}_{x , y} ≡ {\sum }_{k = 0}^{M - 1} \frac{Im [ {R}_{x} ( k ) ] Re [ {R}_{y} ( k ) ] - Re [ {R}_{x } ( k ) ] Im [ {R}_{y} ( k ) ]}{2 D ( k )} = {\sum }_{k = 0}^{M - 1} \frac{{d}_{xk} {c}_{yk} - {c}_{xk} {d}_{yk}}{2 D ( k )} , \qquad$$

where superscript t is the matrix transpose, and Re(), Im() denote the real and imaginary parts, respectively. Let A and B be T×T matrices whose elements at (x, y) are A_{x,y}, and B_{x,y,} respectively. aₖ and bₖ are substituted into the filter constraints and solve for λ₁ᵢ, λ₂ᵢ,

λ₁^{t}=MC^{t}(A+BA⁻¹B)⁻¹, λ₂^{t}=MC^{t}(A+BA⁻¹B)⁻¹ BA⁻¹, (6)

From Eqs. (5) and (6), the k-th element of the distortion tolerant filter H(k) is obtained from:

$$\begin{matrix}{a}_{k} + j {b}_{k} = \frac{1}{2 D ( k )} {\sum }_{i = 1}^{T} [ {λ}_{1 i} ( {c}_{ik} + j {d}_{ik} ) + {λ}_{2 i} ( {d}_{ik} - j {c}_{ik} ) ] \\ = \frac{1}{2 D ( k )} {\sum }_{i = 1}^{T} ( {λ}_{1 i} - j {λ}_{2 i} ) ( {c}_{ik} + j {d}_{ik} ) .\end{matrix} \qquad ( 7 )$$

Both wₙ and w_{d} in D(k) are chosen as M/2.Therefore, the optimum nonlinear distortion tolerant filter H(k) is

$$H ( k ) = \frac{{\sum }_{i = 1}^{T} ( {λ}_{1 i} - j {λ}_{2 i} ) {R}_{i} ( k )}{( \begin{matrix}\begin{matrix}\begin{matrix}\begin{matrix}\frac{1}{M T} {\sum }_{i = 1}^{T} ( {Φ}_{b}^{0} ( k ) ⊗ \{ {\vert W ( k ) \vert}^{2} + {\vert {W}_{ri} ( k ) \vert}^{2} - \\ 2 \frac{{\vert W ( k ) \vert}^{2}}{d} Re [ {W}_{ri} ( k ] \} ) +\end{matrix} \\ \frac{1}{M} {Φ}_{a}^{0} ( k ) ⊗ {\vert W ( k ) \vert}^{2} + \frac{1}{T} {\sum }_{i = 1}^{T} ( m {\sum }_{b}^{2}\end{matrix} \\ \{ {\vert W ( k ) \vert}^{2} + {\vert {W}_{ri} ( k ) \vert}^{2} - 2 \frac{{\vert W ( k ) \vert}^{2}}{d} Re [ {W}_{ri} ( k ) ] \} +\end{matrix} \\ 2 {m}_{a} {m}_{b} {\vert W ( k ) \vert}^{2} Re [ 1 - \frac{{W}_{ri} ( k )}{d} ] ) + {m}_{a}^{2} {\vert W ( k ) \vert}^{2} + {\vert S ( k ) \vert}^{2}\end{matrix} )} , \qquad ( 8 )$$

where Φ_{b}⁰ (k) is the power spectrum of the zero-mean stationary random process n_{b}⁰ (t), and Φₐ⁰ (k) is the power spectrum of the zero-mean stationary random process nₐ⁰ (t). W(k) and Wᵣᵢ(k) are the discrete Fourier transforms of w(t) and wᵣᵢ(t), respectively. [symbol] denotes a convolution operator. λ₁ᵢ and λ₂ᵢ are obtained from Eq. (6).

While the embodiment described above discusses and optimum nonlinear filter, it will be appreciated that this is not a necessary feature. In fact, it is noted that any suitable image recognition or classification algorithm can be used. In at least one embodiment, a classification algorithm can be used before an image recognition algorithm. For example, a classification algorithm could be used to classify a target object as either a car or a truck, and then an image recognition algorithm could be used to further classify the object into a particular type of car or truck.

Additionally, at least the above embodiment describes a distortion tolerant algorithm. Distortion in this context can mean that the target object is different in some way from a reference object used for identification. For example, the target object may be rotated (e.g., in-plane rotation or out of plane rotation), there could be a different scale or magnification from the reference object, the target object may have a different perspective than the reference object, or the target object may be illuminated in a different way than the reference object. It will be understood that these are not the distortion tolerant algorithm is not limited to these examples, and that there are other possible examples of distortion with which the distortion tolerant algorithm would work.

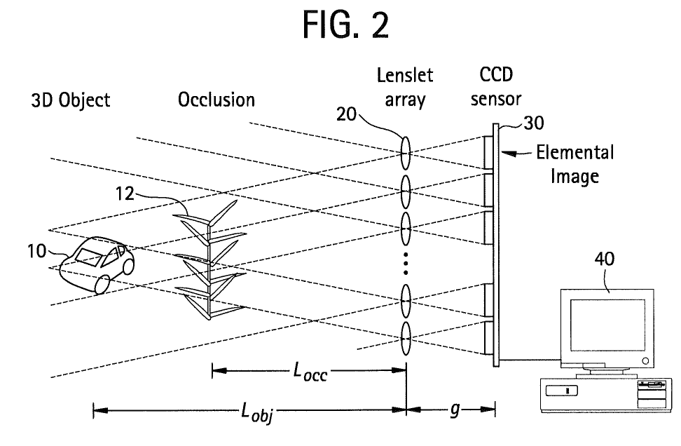

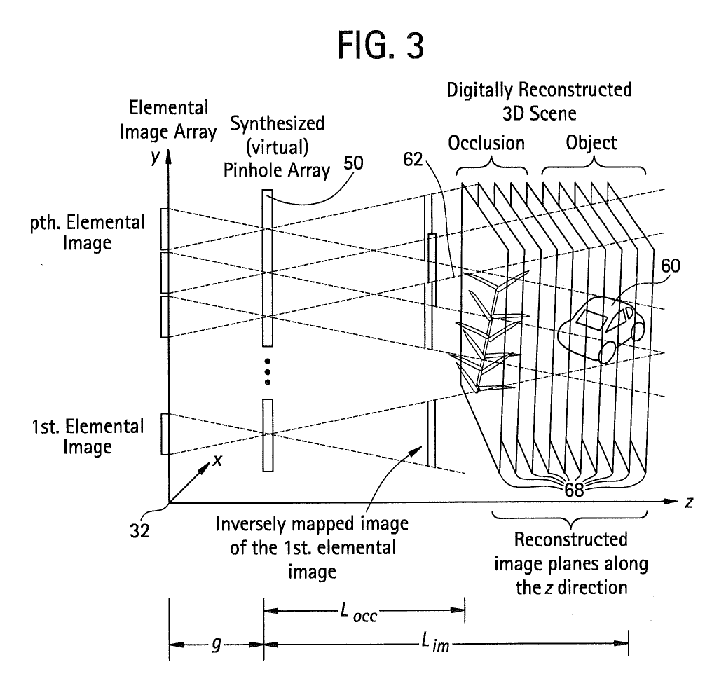

FIG. 2 depicts at least an embodiment of the system setup to capture the occluded 3D scene. Volumetric computational integral imaging reconstruction is performed in a computer 40 or any other suitable processor with a virtual pinhole array 50 using ray optics, as shown in FIG. 3.

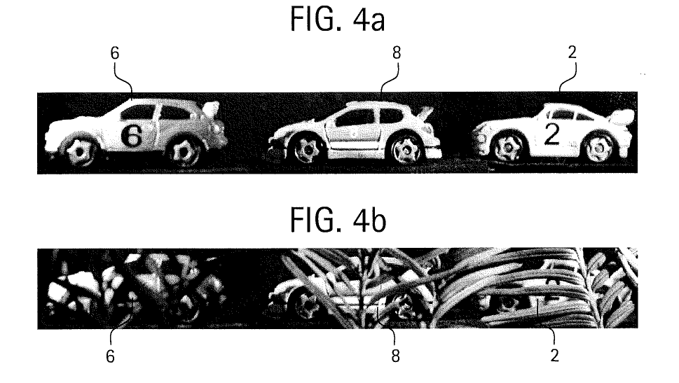

FIG. 4(a) shows an arrangement of toy cars used in testing at least an embodiment of the method and system. Left car 6 is red in color, center car 8 is green in color, and right car 2 is blue in color. In this particular experiment, the dimensions of each of the cars was 3.51 cm×1.3 cm×1.2 cm. The distance between left car 6 and the lenslet 20 array was 45 mm, the distance between center car 8 and the lenslet array 20 was 51 mm, and the distance between right car 2 and the lenslet array was 73 mm.

However, these dimensions are indicated only to summarize the conditions of one particular experimental setup, and are not meant to be limiting in any way.

In the experimental setup shown in FIG. 4(a), the left car 6 is designated as the true class object. Natural vegetation can be used as occlusions positioned approximately 2 cm in front of each car, as shown in FIG. 4(b). As seen in FIG. 4(b), many of the details of the objects have been lost because of the occlusion.

To compare the performance of a filter for various schemes, a peak-intensity-to-sidelobe ratio (PSR) is used. The PSR is a ratio of the target peak intensity to the highest sidelobe intensity:

PSR=peak intensity/highest sidelobe intensity

Using a conventional 2D optimum filter for the 2D scene, the output peak intensity of the red occluded car is 0.0076. The PSR of the 2D correlation for the occluded input scene is 1.5431.

In the experiments for recognition with 3D volumetric reconstruction, an integral imaging system is used for picking up the elemental images with a lenslet array with pitch p=1.09 mm and a focal length of 3 mm. The cars are located the same distance from the lenslet array as in the previous experiment to obtain a 19×94 elemental image array. The resolution of each elemental image is 66×66 pixels.

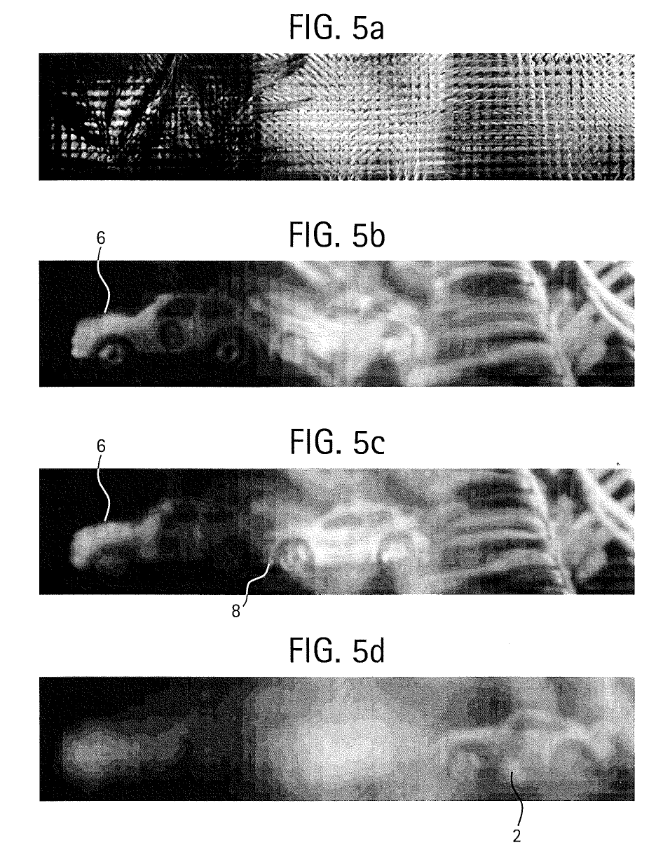

A digital 3D reconstruction was performed in order to obtain the original left car 6, as seen in FIGS. 5(a)-5(d). In FIG. 5(a), distance z from the virtual pinhole array 50 to the display plane 68 was 10.7 mm; in FIG. 5(b), z=44.94 mm; in FIG. 5(c), z 51.36 mm; and in FIG. 5(d), z=72.76 mm. A second elemental image array is picked up by using occlusion at a location of about 2 cm in front of each car. As shown in FIGS. 5(a)-5(d), the complete scene can be reconstructed from the elemental images while reducing the effect of the occlusion at various distances from the lenslet array.

The output peak intensity of the left car 6 is 0.1853, and the PSR for the output plane showing the left car 6 (i.e., FIG. 5(b)) is 108.4915. The lowest PSR for the entire set of reconstructed planes from z=10.7 mm to z=96.3 mm is 6.062, which is four times higher than the PSR of the 2D image correlation. The comparison of the PSR and the intensities of the conventional 2D image correlation and 3D computational volumetric reconstructed image correlation are shown below:

| | | Correlation with 3D volumetric | |
|---|---|---|---|
| | Correlation with | reconstruction | |
| | Conventional 2D | Peak plane | Lowest |
| | imaging | at 44.94 mm | PSR |
| Peak intensity | 0.0076 | 0.1853 | 0.1853 |
| Maximum sidelobe | 0.0050 | 0.0017 | 0.0306 |
| intensity | | | |
| PSR | 1.5341 | 108.4915 | 6.0556 |

These experimental results show that the performance of the proposed recognition system with 3D volumetric reconstruction for occluded objects is superior to the performance of the correlation of the occluded 2D images.

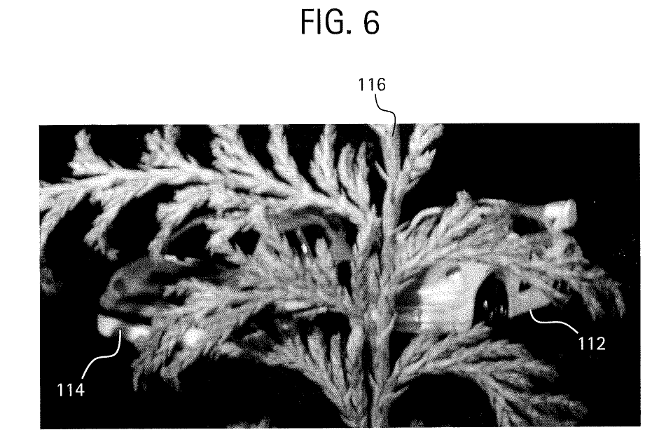

FIG. 6 shows another experimental setup in which two toy cars and foreground vegetation illuminated by incoherent light are used in the experiments. In the experiment, the solid car 114 on the left was green in color, and the striped car 112 on the right was blue in color. They are referred to herein as a solid car 114 and striped car 112 for ease of understanding when looking at black and white figures; however, these designations are not meant to be limiting in any way.

The pickup microlens array 20 is placed in front of the object to form the elemental image array. In the embodiment shown in FIG. 6, the distance between the microlens array and the closest part of the occluding vegetation 116 is around 30 mm, the distance between the microlens array and the front part of the solid car 114 is 42 mm, and the distance between the microlens array and the front part of the striped car 112 is 52 mm. The minimum distance between the occluding object 116 and a pixel on the closest background object should be equal to or greater than 9.6 mm, where the rhombus index number in the experiments is 7 for the solid car 114. This satisfies the constraint of the experimental setup to reconstruct the background objects 112, 114. The background objects 112, 114 are partially occluded by foreground vegetation 116, thus, it is difficult to recognize the occluded objects 112, 114 from the 2D scene in FIG. 6. The elemental images of the object are captured with the digital camera 30 (or any other CCD device or other suitable device) and the pickup microlens array 20. The microlens array used in at least one embodiment of the system has 53×53 square refractive lenses in a 55 mm×55 mm square area. The size of each lenslet in at least one embodiment of the system is 1.09 mm×1.09 mm, with less than 7.6 μm separation. The focal length of each microlens in at least one embodiment of the system is 3.3 mm. The size of each captured elemental image is 73 pixels×73 pixels. However, it will be understood that various configurations and parameters are also possible in other embodiments.

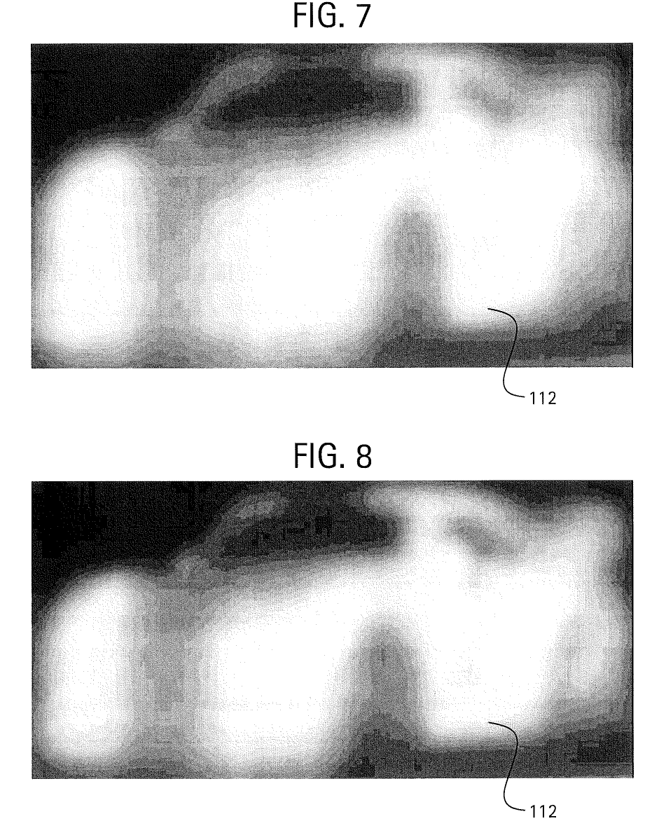

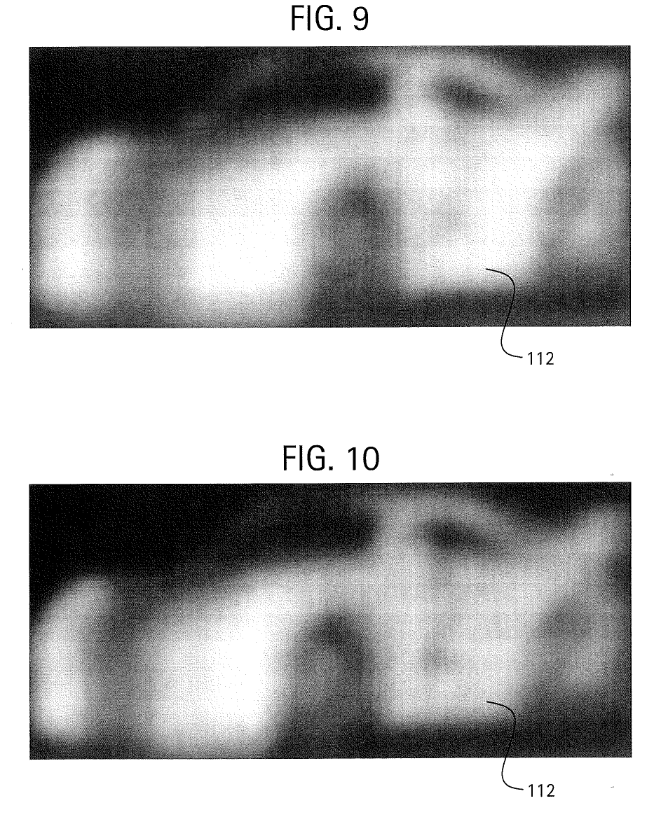

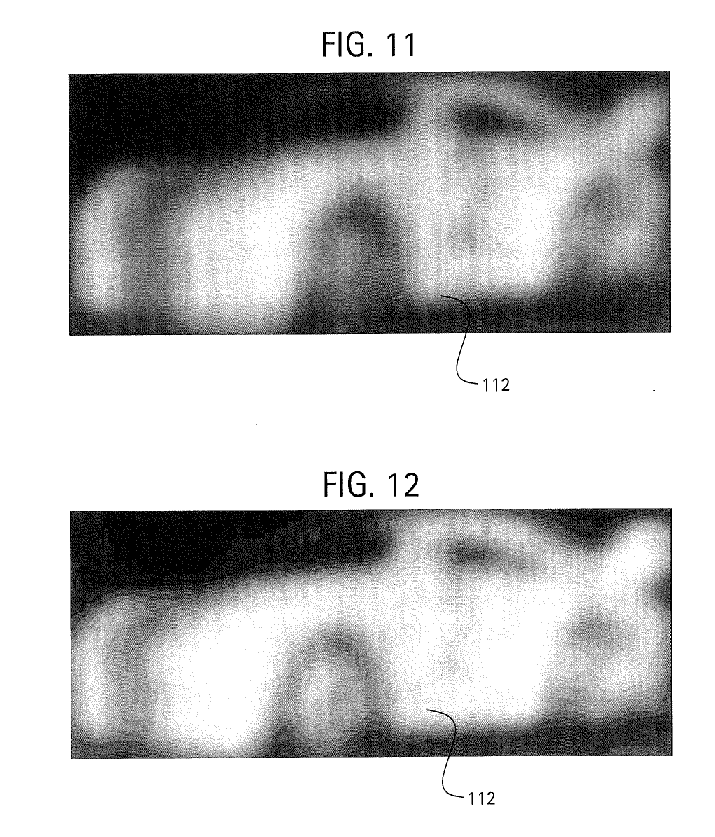

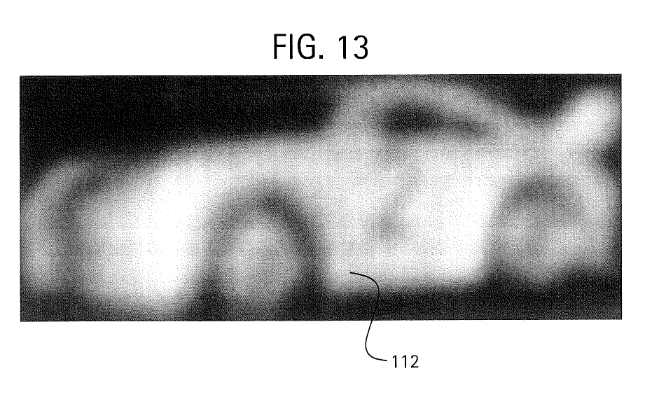

The striped car 112 is a true class target, and the solid car 114 is a false object. In other words, it is desired to detect only the striped car 112 in a scene that contains both of the solid car 114 and striped car 112. Because of the similarity of the shape of the cars used in the experiments, it is difficult to detect the target object with linear filters. Seven different elemental image sets are obtained by rotating the reference target from 30° to 60° in 5° increments. One of the captured elemental image sets that are used to reconstruct the 3D training targets are shown in FIG. 18. Examples reconstructed image planes from the elemental image sets are shown in FIGS. 7-13. In these reconstructed images, the object is rotated at various angles: 30 degrees in FIG. 7, 35 degrees in FIG. 8, 40 degrees in FIG. 9, 45 degrees in FIG. 10, 50 degrees in FIG. 11, 55 degrees in FIG. 12, and 60 degrees in FIG. 13.

From each elemental image set with rotated targets, we have reconstructed the images from z=60 mm to z=72 mm in 1 mm increments. Therefore, for each rotated angle (from 30° to 60° in 5° increments) 13 reconstructed images are used as a 3D training reference target. As rotation angle increases, one can observe more of the side view of the object and less frontal view. The input elemental images have a true class training target, or a true class non-training target and a false object (solid car 114). True class training target is a set of 13 reconstructed images of the striped car 112 rotated at 45°. True class non-training target is a set of 13 reconstructed images of the solid car 114 rotated at 32.5°, which is not from the training reference targets. True class training and non-training targets are located on the right side of the input scene and the false object is located at the left side of the scene. The true class non-training target used in the test is distorted in terms of out-of-plane rotation, which is challenging to detect.

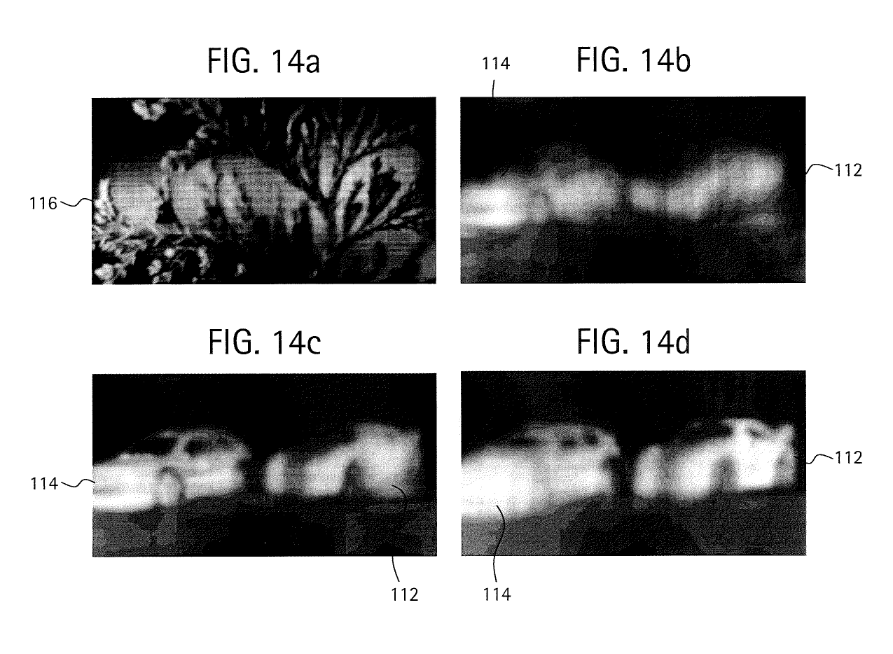

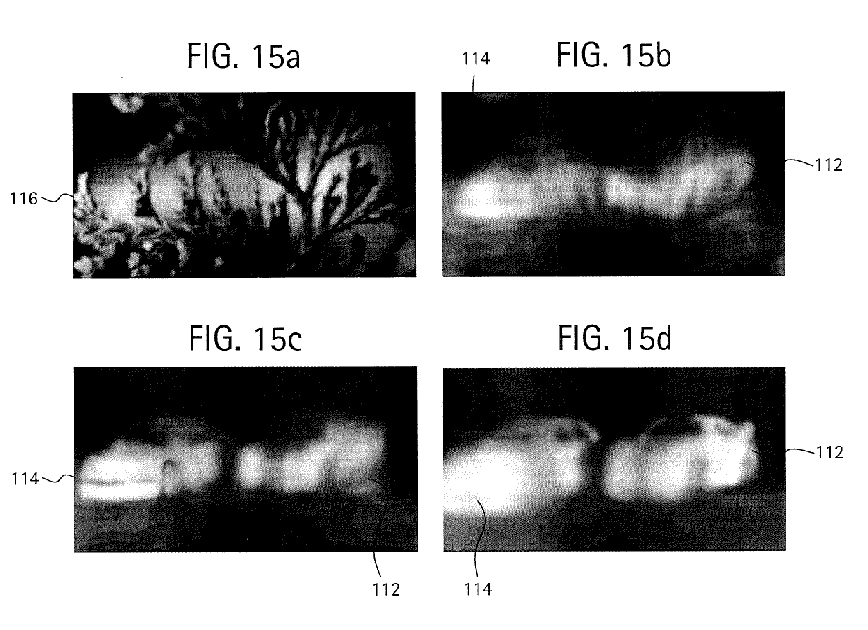

FIGS. 14(a)-14(d) show the reconstructed 3D scene from the elemental images of the occluded true class training target scene with the false object taken at an angle of 45° with various longitudinal distances. Similarly, FIGS. 15(a)-15(d) show the reconstructed 3D scene from the elemental images of the occluded true class non-training target scene with the false object taken at an angle of 32.5° with various longitudinal distances. With volumetric computational integral imaging reconstruction, it is possible to separate the foreground occluding object and background occluded objects with the reduced interference of the foreground objects.

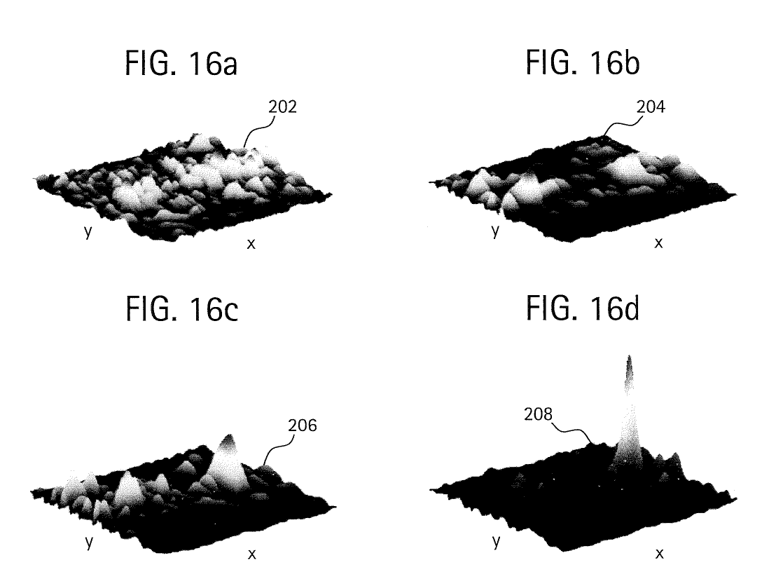

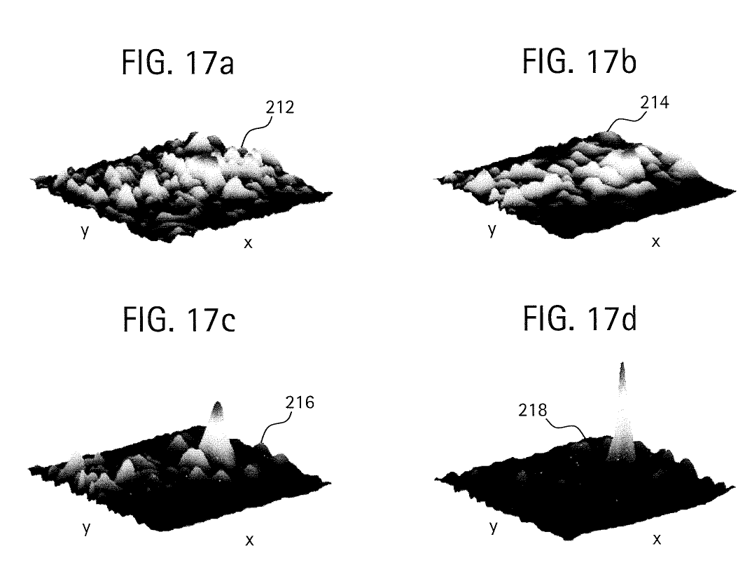

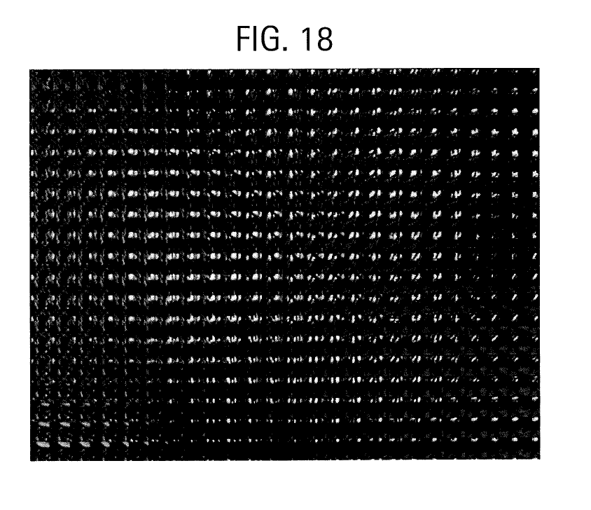

The distortion tolerant optimum nonlinear filter has been constructed in a 4D structure, that is, x, y, z coordinates (i.e., spatial coordinates) and 3 color components. FIGS. 16(a)-16(d) and 17(a)-17(d) are visualizations of the 4D optimum nonlinear filter at different longitudinal depth levels. We set all of the desired correlation values of the training targets, Cᵢ, to 1 [see Eq. (2)]. FIGS. 16(a)-16(d) are the normalized outputs of the 4D optimum nonlinear distortion tolerant filter in Eq. (8) at the longitudinal depth levels of the occluding foreground vegetation, the true class training target, and the false object, respectively (see graphs 202, 204, 206, 208). A dominant peak only appears at the true class target distance, as shown in FIG. 16(d). FIGS. 17(a)-17(d) are the normalized outputs of the 4D optimum nonlinear distortion tolerant filter at the longitudinal levels of the occluding foreground vegetation, the true class non-training target, and the false object, respectively (see graphs 212, 214, 216, 218).

FIG. 17(d) shows a dominant peak at the location of the true class non-training target. The peak value of the true class training target is higher than that of the true class non-training target. The ratio of the non-training target peak value to the training target peak value is 0.9175. The ratio of the peak value to the maximum side-lobe is 2.8886 at the 3D coordinate of the false object. It is possible to distinguish the true class targets and false object or occluding foreground objects.

Because of the constraint of the minimum distance between the occluding object and a pixel on the background object, the experimental setup is very important to reconstruct the background image with a reduced effect of the foreground occluding objects. One of the parameters to determine the minimum distance is the density of the occluding foreground object. If the density of the foreground objects is high, the background object should be farther from the image pickup system. If not, the background objects may not be fully reconstructed, which can result in poor recognition performance. Nevertheless, even in this case, the proposed approach gives us better performance than that of the 2D recognition systems [18].

Using a 3D computational volumetric II reconstruction system and a 3D distortion tolerant optimum nonlinear filtering technique, a partially occluded and distorted 3D objects can be recognized in a 3D scene. The experimental results show that the background objects can be reconstructed with the reduced effect of occluding foreground. With the distortion tolerant 4D optimum nonlinear filter (3D coordinates plus color), one sees the recognition capability of the rotated 3D targets when the input scene contains false objects and is partially occluded by foreground objects such as vegetation.

The above description discusses the methods and systems in the context of visible light imaging. However, it will also be understood that the above methods and systems can also be used in multi-spectral applications, including, but not limited to, infrared applications as well as other suitable combinations of visible and non-visible light. For example, in the context of the embodiments described above, in at least an embodiment the plurality of elemental images may be generated using multi-spectral light or infrared light, and the CCD camera may be structured to record multi-spectral light or infrared light.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A method for three-dimensional image reconstruction and target object recognition comprising:
acquiring a plurality of elemental images of a three-dimensional scene through a microlens array;
generating a reconstructed display plane based on the plurality of elemental images using three-dimensional volumetric computational integral imaging; and
recognizing the target object in the reconstructed display plane by using a three-dimensional optimum nonlinear filter H(k);
wherein the three-dimensional optimum nonlinear filter H(k) is given by the equation:
$$H ( k ) = \frac{{\sum }_{i = 1}^{T} ( {λ}_{1 i} - j {λ}_{2 i} ) {R}_{i} ( k )}{( \begin{matrix}\begin{matrix}\begin{matrix}\begin{matrix}\frac{1}{M T} {\sum }_{i = 1}^{T} ( {Φ}_{b}^{0} ( k ) ⊗ \{ {\vert W ( k ) \vert}^{2} + {\vert {W}_{ri} ( k ) \vert}^{2} - \\ 2 \frac{{\vert W ( k ) \vert}^{2}}{d} Re [ {W}_{ri} ( k ] \} ) +\end{matrix} \\ \frac{1}{M} {Φ}_{a}^{0} ( k ) ⊗ {\vert W ( k ) \vert}^{2} + \frac{1}{T} {\sum }_{i = 1}^{T} ( m {\sum }_{b}^{2}\end{matrix} \\ \{ {\vert W ( k ) \vert}^{2} + {\vert {W}_{ri} ( k ) \vert}^{2} - 2 \frac{{\vert W ( k ) \vert}^{2}}{d} Re [ {W}_{ri} ( k ) ] \} +\end{matrix} \\ 2 {m}_{a} {m}_{b} {\vert W ( k ) \vert}^{2} Re [ 1 - \frac{{W}_{ri} ( k )}{d} ] ) + {m}_{a}^{2} {\vert W ( k ) \vert}^{2} + {\vert S ( k ) \vert}^{2}\end{matrix} )} ,$$
wherein T is the size of a reference target set;
λ₁ᵢ and λ₂ᵢ are Lagrange multipliers;
Rᵢ(k) is a discrete Fourier transform of an impulse response of a distorted reference target;
M is a number of sample pixels;
d is an area of a support region of the three dimensional scene;
Re[ ] is an operator indicating the real part of an expression
mₐ is a mean of overlapping additive noise;
m_{b} is a mean of non-overlapping background noise;
Φ_{b}⁰ (k) is a power spectrum of a zero-mean stationary random process n_{b}⁰ (t), and Φₐ⁰ (k) is a power spectrum of a zero-mean stationary random process nₐ⁰ (t);
S(k) is a Fourier transform of an input image;
W(k) is a discrete Fourier transform of a window function for the three-dimensional scene;
and Wᵣᵢ(k) is a discrete Fourier transform of a window function for the reference target; and [symbol]
denotes a convolution operator.

2. A system for three-dimensional reconstruction of a three-dimensional scene and target object recognition, comprising:
a CCD camera structured to record a plurality of elemental images;
a microlens array positioned between the CCD camera and the three-dimensional scene;
a processor connected to the CCD camera, the processor being structured to generate a reconstructed display plane based on the plurality of elemental images using three-dimensional volumetric computational integral imaging and structured to recognize the target object in the reconstructed display plane by using a three-dimensional optimum nonlinear filter H(k);
wherein the three-dimensional optimum nonlinear filter H(k) is given by the equation:
$$H ( k ) = \frac{{\sum }_{i = 1}^{T} ( {λ}_{1 i} - j {λ}_{2 i} ) {R}_{i} ( k )}{( \begin{matrix}\begin{matrix}\begin{matrix}\begin{matrix}\frac{1}{M T} {\sum }_{i = 1}^{T} ( {Φ}_{b}^{0} ( k ) ⊗ \{ {\vert W ( k ) \vert}^{2} + {\vert {W}_{ri} ( k ) \vert}^{2} - \\ 2 \frac{{\vert W ( k ) \vert}^{2}}{d} Re [ {W}_{ri} ( k ] \} ) +\end{matrix} \\ \frac{1}{M} {Φ}_{a}^{0} ( k ) ⊗ {\vert W ( k ) \vert}^{2} + \frac{1}{T} {\sum }_{i = 1}^{T} ( m {\sum }_{b}^{2}\end{matrix} \\ \{ {\vert W ( k ) \vert}^{2} + {\vert {W}_{ri} ( k ) \vert}^{2} - 2 \frac{{\vert W ( k ) \vert}^{2}}{d} Re [ {W}_{ri} ( k ) ] \} +\end{matrix} \\ 2 {m}_{a} {m}_{b} {\vert W ( k ) \vert}^{2} Re [ 1 - \frac{{W}_{ri} ( k )}{d} ] ) + {m}_{a}^{2} {\vert W ( k ) \vert}^{2} + {\vert S ( k ) \vert}^{2}\end{matrix} )} , \qquad$$
wherein T is the size of a reference target set;
λ₁ᵢ and λ₂ᵢ are Lagrange multipliers;
Rᵢ(k) is a discrete Fourier transform of an impulse response of a distorted reference target;
M is a number of sample pixels;
d is an area of a support region of the three dimensional scene;
Re[ ] is an operator indicating the real part of an expression
mₐ is a mean of overlapping additive noise;
m_{b} is a mean of non-overlapping background noise;
Φ_{b}⁰ (k) is a power spectrum of a zero-mean stationary random process n_{b}⁰ (t), and Φₐ⁰ (k) is a power spectrum of a zero-mean stationary random process n^{a}⁰ (t);
S(k) is a Fourier transform of an input image;
W(k) is a discrete Fourier transform of a window function for the three-dimensional scene;
and Wᵣᵢ (k) is a discrete Fourier transform of a window function for the reference target; and [symbol]
denotes a convolution operator.

3. A method for three-dimensional reconstruction of a three-dimensional scene and target object recognition comprising:
acquiring a plurality of elemental images of a three-dimensional scene through a microlens array;
generating a reconstructed display plane based on the plurality of elemental images using three-dimensional volumetric computational integral imaging; and
recognizing the target object in the reconstructed display plane by using an image recognition or classification algorithm.

4. The method of claim 3, wherein the three-dimensional scene comprises a background object and foreground object, wherein the foreground object at least partially occludes, obstructs, or distorts the background object.

5. The method of claim 3, wherein the generating a reconstructed display plane comprises inverse mapping through a virtual pinhole array.

6. The method of claim 3 wherein the generating a reconstructed display plane is repeated for a plurality of reconstruction planes to thereby generate a reconstructed three-dimensional scene.

7. The method of claim 4 wherein the effect of the occlusion, obstruction, or distortion caused by the foreground object is minimized when recognizing the target object.

8. The method of claim 3 wherein the three-dimensional scene comprises an object of military, law enforcement, or security interest.

9. The method of claim 3 wherein the 3D scene of interest comprises an object of scientific, biological, or medical interest.

10. The method of claim 3, wherein the image recognition or classification algorithm is an optimum nonlinear filter.

11. The method of claim 10, wherein the optimum nonlinear filter is constructed in a four dimensional structure.

12. A system for three-dimensional reconstruction of a three-dimensional scene and target object recognition, comprising:
a CCD camera structured to record a plurality of elemental images;
a microlens array positioned between the CCD camera and the three-dimensional scene;
a processor connected to the CCD camera, the processor being structured to generate a reconstructed display plane based on the plurality of elemental images using three-dimensional volumetric computational integral imaging and structured to recognize the target object in the reconstructed display plane by using an image recognition or classification algorithm.

13. The system of claim 12, wherein the image recognition or classification algorithm is an optimum nonlinear filter.

14. The system of claim 13, wherein the optimum nonlinear filter is constructed in a four-dimensional structure.

15. The system of claim 12, wherein the processor is structured to generate reconstructed display plane by inverse mapping through a virtual pinhole array.

16. The method of claim 3, wherein the optimum nonlinear filter is a distortion-tolerant optimum nonlinear filter.

17. The system of claim 12, wherein the optimum nonlinear filter is a distortion-tolerant optimum nonlinear filter.

18. The method of claim 16, wherein the distortion-tolerant optimum nonlinear filter is designed with a training data set of reference targets to recognize the target object when viewed from various rotated angles, perspectives, scales, or illuminations.

19. The method of claim 17, wherein the distortion-tolerant optimum nonlinear filter is designed with a training data set of reference targets to recognize the target object when viewed from various rotated angles, perspectives, scales, or illuminations.

20. The method of claim 3, wherein the plurality of elemental images are generated using multi-spectral light.

21. The method of claim 3, wherein the plurality of elemental images are generated using infrared light.

22. The system of claim 12, wherein the CCD camera is structured to record multi-spectral light.

23. The system of claim 12, wherein the CCD camera is structured to record infrared light.

24. The method of claim 11, wherein the four-dimensional structure of the optimum nonlinear filter includes spatial coordinates and a color component.

25. The system of claim 14, wherein the four-dimensional structure of the optimum nonlinear filter includes spatial coordinates and a color component.
